(19) United States
(12) Patent Application Publication
(10) Pub. No.: US 2012/0205041 A1
(43) Pub. Date: Aug. 16, 2012

(54) Method of Assembling a Hollow Fiber Bioreactor

(75) Inventor: Fredrik Dalborg, Tervuren (BE)

(73) Assignee: TERUMO BCT, INC., Lakewood, CO (US)

(21) Appl. No.: 13/500,737

(22) PCT Filed: Oct. 4, 2010
(86) PCT No.: PCT/IB10/02517

§ 371 Date: Apr. 6, 2012

Related U.S. Application Data
(60) Provisional application No. 61/250,758, filed on Oct. 12, 2009.

(51) Int. Cl. B29C 65/14

(52) U.S. Cl. 156/272.6

(57) ABSTRACT

The present invention relates to a method of assemblying a cell growth module, and preventing the formation of cytotoxic chemicals in the cell growth module which may interfere with the growth of the cells in the cell growth module. Electromagnetic radiation such as gamma irradiation may be used to treat the membrane surface prior to the membrane being inserted into the housing. The cell growth module includes at least a membrane and a housing.

### FIELD OF THE INVENTION

The instant invention relates to a method of treating a membrane surface before assembling such surfaces into a bioreactor.

### BACKGROUND OF THE INVENTION

The use of stem cells in a variety of medical treatments and therapies is receiving growing attention. Cell expansion systems can be used to grow stem cells, as well as other types of cells, such as bone marrow cells which may include stem cells. Stem cells which are expanded from donor cells can be used to repair or replace damaged or defective tissues and are considered for treating a wide range of diseases.

As an important component of a cell expansion system, a bioreactor, or cell growth chamber plays an important role in providing optimized environments for cell expansion. The bioreactor provides efficient nutrient supply to the cells and removal of metabolites, as well as furnishing a physiochemical environment conducive to cell growth.

Many types of bioreactors are currently available. Two of the most common include flat plate bioreactors and hollow fiber bioreactors. Flat plate bioreactors enable cells to grow on large flat surfaces, while hollow fiber bioreactors enable cells to grow on either the interior or exterior surface of the hollow fibers. The membranes are typically bundled together and enclosed within a casing or housing.

Many of the cells used to repair or replace damaged tissue are adherent cells. Adherent cells are defined in the context to the present invention as cells attaching to a substrate which are to be maintained, expanded, differentiated stored etc. Mesenchymal stem cells are adherent cells. Adherent cells, unlike suspension cells, can grow and divide only if they are attached to a surface.

Membranes which are commonly used to grow adherent cells may be made of naturally occurring material such as cellulose, or of man-made materials such as synthetic polymers. If the membranes are made of synthetic polymeric material, the surface of the material must be treated before cells are introduced into the system to enable the cells to adhere to the membrane.

Proteins such as fibronectin or those found in plasma are examples of naturally-occurring materials which are commonly used to coat the membranes. Gamma irradiation, electron beam graft polymerization and plasma treatment are examples of procedures used to chemically modify the membrane surface using radiation for cell adherance.

Membranes are typically treated with proteins or irradiated after the fibers have been enclosed in the housing. If radiation is used, the high doses of radiation required to modify the surface of the membranes may cause the unwanted side effect of breaking down other components of the bioreactor. Breakdown of the bioreactor housing may cause release of cytotoxic products into the cell growth area which may leach into the hollow fibers, inhibiting the growth of cells in the bioreactor. Current practice is to extensively rinse the bioreactor with various solutions to remove any toxic products before cells are placed in the bioreactor. This is done at the time of use, using several liters of electrolyte solutions in conjunction with an overnight exposure to a protein containing media.

PCT application PCT/EP2009/006847 (W02010/034466) teaches use of a synthetic PES/PVP/PA membrane used to grow adherent cells wherein the membrane after production is subjected to beta or gamma ray or electron beam irradiation in a dose of from 12.5 to 175 kGy in the presence of oxygen. In this invention, the hollow fibers were assembled into a housing, potted, and the assembled bioreactor was gamma-ray irradiated as a final step before use.

In actual use, the inventor of the present invention found that the gamma-irradiation process used to treat the synthetic membranes also damaged the housing. Irradiating the housing produced polymer breakdown products that were cytotoxic to the cells. Therefore, when using such a bioreactor, the cytotoxic products must be removed before cells are introduced into the bioreactor. This is done by washing the bioreactor multiple times before cell introduction.

Preventing the formation of cytotoxic products from the bioreactor as a result of irradiating the membrane would minimize the time and materials the end user spends decontaminating the bioreactor before use, as well as reducing the risk of contamination brought with the multiple rinsing steps and solutions. It is to the prevention of cytotoxic products contaminating the bioreactor that the present invention is directed.

### SUMMARY OF THE INVENTION

It is an object of the invention to prepare the surfaces of the polymeric membranes with electromagnetic radiation, while preventing the formation of cytotoxic products caused by irradiation of the polymeric housing of the cell growth module. This is accomplished by treating the membrane with electromagnetic radiation before placing it in the polymeric casing.

### BRIEF DESCRIPTION OF THE DRAWINGS

FIG. 1 illustrates an unassembled bundle of hollow fiber membranes to be used in a hollow fiber bioreactor.

FIG. 2 is an external view of a polymeric housing including end caps of a hollow fiber bioreactor.

FIG. 3 is a cross-sectional view of a cell growth module comprising a housing with the hollow fiber membrane inside.

FIG. 4 illustrates a method of assembling a cell growth module without producing cytotoxins.

### DETAILED DESCRIPTION OF THE INVENTION

The membrane of the present invention can have various geometries. Although hollow fiber membranes are shown in the figures, the method of the present invention can be used with all forms of membranes, including flat sheet membranes. Hollow fiber membranes in cell growth systems have been shown to be favorable for cell expansion because the membranes in these systems allow for efficient supply of nutrients to the cells, removal of waste, and exchange of gases. Also, the hollow fibers provide a large surface area for cells to grow on in comparison to the volume of the membrane.

In the embodiments shown in the figures, cells may be grown inside the lumen or intracapillary space (IC space) of the hollow fibers, while cell growth media is flowed along the outside of the hollow fibers or extracapillary space (EC space). However, for the purposes of the invention, cells could also be grown in the EC space while the cell growth media is flowed in the IC space without departing from the spirit and scope of the invention.

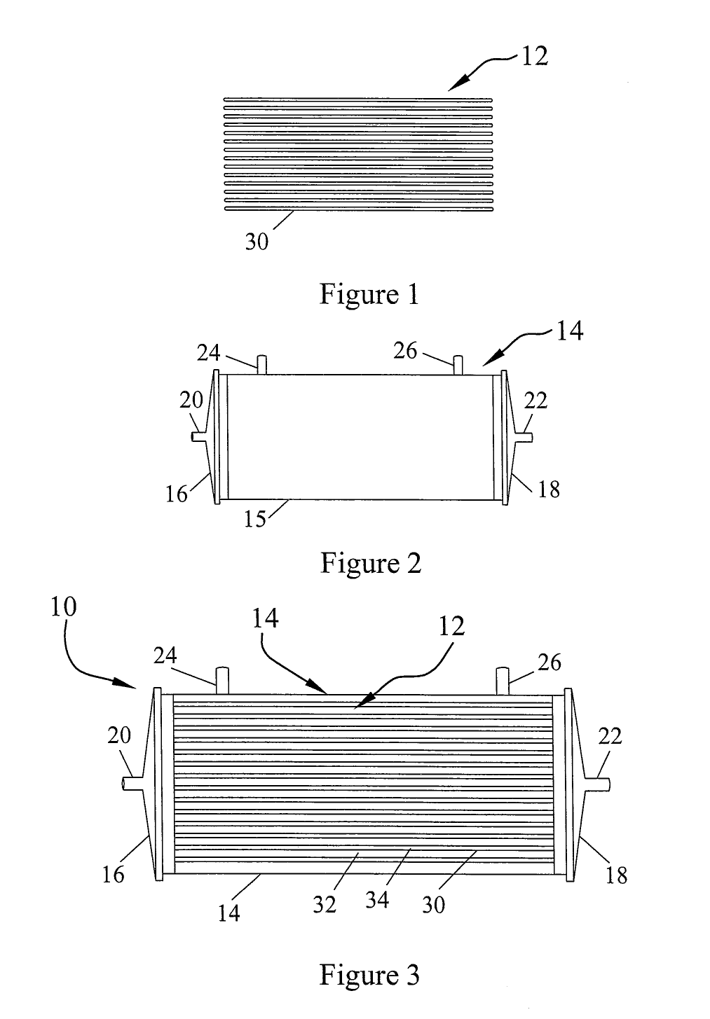

FIG. 1 illustrates a bundle of polymeric hollow fiber membranes 12 containing individual hollow fibers 30 which may be used in a bioreactor. An example of polymeric material which may be used to make the hollow fibers is described below. A plurality of hollow fibers are collectively referred to as a “membrane.” The terms “bioreactor” and “cell growth chamber” are used interchangeably.

Any number of hollow fibers can be used in a cell growth chamber, provided the hollow fibers can be fluidly associated with the inlet and outlet ports of the cell growth chamber.

The hollow fibers may be made of a semi-permeable, biocompatible polymeric material. The semi-permeable membrane allows transfer of nutrients, waste and dissolved gases through the membrane between the EC space and IC space. In various embodiments, the molecular transfer characteristics of the hollow fiber membranes are chosen to minimize loss of expensive reagents necessary for cell growth such as growth factors, cytokines etc. from the cell growth side of the hollow fiber, while allowing metabolic waste products to diffuse through the membrane into the non-cellular side to be removed.

The hollow fibers 30 may be comprised of at least one hydrophobic polymer and at least one hydrophilic polymer. Suitable hydrophobic polymers include blends of polyethersulfone, polyamide, polyaramide, polyarylethersulfone, polyethersulfone, polysulfone, polyarylsulfone, polycarbonate, polyether, polyurethane, polyetherimode, and copolymers of those polymers. Suitable hydrophilic polymers include polyvinylpyrrolidone, polyethylene glycol, polyglycolmonoester, water soluble cellulosic derivates, polysorbate and polyethylene-polypropylene oxide copolymers.

In certain variations, the outer layer of each hollow fiber is characterized by a homogenous and open pore structure with a smooth or low surface roughness on the inner layer or cell adhesion side. The openings of the pores are in the size range of 0.5-3 um, and the number of pores on the outer surface of the fibers are in the range of 10,000 to 150,000 pores per mm². This outer layer has a thickness of about 1 to 10 um. The next layer in each hollow fiber is a second layer having the form of a sponge structure and, in a preferred embodiment of the present invention further embodiment, a thickness of about 1 to 15 um. This second layer serves as a support for the outer layer. A third layer next to the second layer has the form of finger-like structures. This third layer provides mechanical stability and a high void volume which gives the membrane a very low resistance to transporting molecules through the membrane. During use, the finger-like voids are filled with fluid and the fluid gives a lower resistance for diffusion and convection than a matrix with a sponge-filled structure having a lower void volume. This third layer has a thickness of 20 to 60 um.

Membranes such as those described above are commercially available from companies such as Gambro Dialysatoren GmbH (Hechingen, DE) and Membrana GmbH (Wuppertal, DE).

As discussed above, if adherent cells such as mesenchymal stem cells are to be expanded in a cell growth chamber, the polymeric fibers in such chamber must be surface modified to enhance cell growth and/or adherence of the cells to the membrane. Surface modification using naturally-occurring substances such as fibronectin, laminin, and collagen is commonly done, however, such surface treatments generally prevent the bioreactor from being reused. Therefore, surface modification using gamma-irradiation or plasma treatment to modify the membrane surface and allow membrane reuse is desirable.

The dose of gamma radiation used to treat the fibers ranges from 12.5 to 175 kGy. The radiation dose should be high enough to modify the surface of the membrane, but not so high as to disintegrate the membrane itself. Gamma irradiation can be administered using a Co-60 source. The membrane can be wet or dry when subjected to gamma irradiation, including from a complete absence of water to a total submersion in water. Although the amount of irradiation time necessary to apply the desired dose will vary with factors such as the strength of the source of irradiation, the membrane likely will require 6-7 hours of irradiation for a 25 kilogray dose and 17-20 hours for a 75 kilogray dose. Higher doses of radiation may be necessary for membranes that are saturated with water. The membrane can be gamma irradiated in unmodified air or in air with increased oxygen. After irradiation, the membrane surface is ready to be used for direct cell attachment and growth with no further treatment.

Plasma treatment, particularly gas plasma treatment, may also be used to modify surfaces of membranes. Radio frequency glow discharge is one particular example of gas plasma treatment. To begin this type of gas plasma treatment, the membrane is placed into a vacuum chamber and gas is applied at a low pressure. An electromagnetic field or gas plasma is generated by subjecting the gas to an inductive or capacitive radio frequency electrical discharge. The gas absorbs energy from the electromagnetic field and ionizes, producing high-energy particles used to modify the surface of the membrane. The energized particles in a gas plasma include ions, electrons, radicals, and photons in the short wave ultraviolet light range, providing energy that transfers from the plasma to the membrane surface. Appropriate gases include inorganic gases such as helium, argon, and oxygen, and organic gases such as acetylene and pyridine, or a mix of both inorganic and organic gases. In general, power levels ranging between 10 watts and 3000 watts are acceptable, radio frequency frequency can range from 1 kHz to 100 MHz, with exposure times from 5 seconds to 12 hours, and gas pressures can range between 0.001 to 100 torr.

A combination of radiation and gas plasma may also be used.

FIG. 2 illustrates a housing or casing 14 into which a bundle of treated hollow fiber membranes 12 may be inserted. The housing 14 includes endcaps 16 and 18, inlet ports 20 and 24, outlet ports 22 and 26, and a sleeve 15.

Although cell growth chamber housing 14 is depicted as being cylindrical in shape, it can have any shape known in the art. Cell growth chamber housing 14 can be made of any type of biocompatible polymeric material known in the art such as polyvinylchloride or polycarbonate. The sleeve 15 and various component parts such as the end caps 16, 18 and ports 24, 26 are also typically made of biocompatible polymeric material.

FIG. 3 illustrates a cross-section of an assembled cell growth module 10. The cell growth module 10 comprises a housing 14 and a bundle of hollow fiber membranes 12. The hollow fiber membranes 12 are positioned inside the housing 14 of the cell growth module 10.

In assembling the cell growth module 10, the individual hollow fibers 30 are bundled together and adhered to the ends of the cell growth chamber by a connective material (also referred to herein as “potting” or “potting material”). The potting can be any suitable biocompatible material provided that the flow of media and cells from the inlet port into the hollow fibers is not obstructed and that the media and cells flow only into the hollow fibers. Exemplary potting material includes, but is not limited to, polyurethane. In various embodiments, the hollow fibers and potting may be cut through perpendicular to the central axis of the hollow fibers at each end to permit fluid flow into and out of the lumen of the fibers. End caps 16 and 18 are disposed at each end of the cell growth chamber.

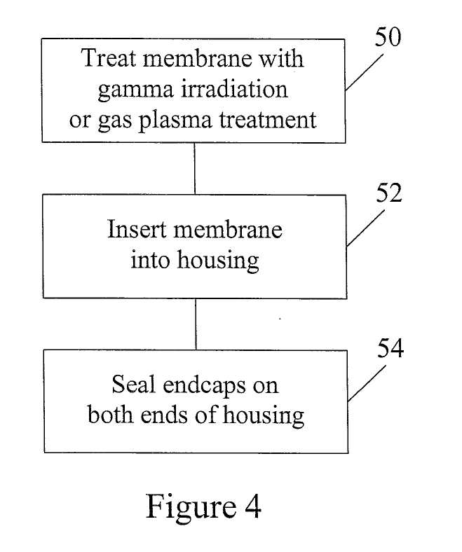

FIG. 4 illustrates a method for assembling a cell growth module 10 without producing cytotoxins due to exposing the housing 14 to electromagnetic radiation. First, the fibers are treated with gamma irradiation and/or plasma treatment 50. Next, the treated membrane 12 is inserted into the housing and potted 52. Finally, end caps 16 and 18 are placed on each end of the sleeve 15 and sealed closed 54. It should be noted that the fibers may be treated before or after forming them into a bundle for insertion into the housing.

No further surface treatment of the membrane 12 is necessary; thus the polymeric housing or casing 14 is not exposed to electromagnetic radiation, and thus the formation of cytotoxic products which inhibits cell growth is avoided.

1. A method of assembling a cell growth module comprising a synthetic polymeric membrane and a synthetic polymeric housing, the method comprising:
treating the membrane using electromagnetic radiation to modify the surface of the membrane to cause cells to adhere to the membrane,
inserting the membrane into the housing after the treating step to form the cell growth module.

2. The method of claim 1, wherein the membrane is a hollow fiber membrane.

3. The method of claim 2 further comprising bundling the hollow fibers prior to the treating step.

4. The method of claim 2 further comprising bundling the hollow fibers after the treating step.

5. The method of claim 2 further comprising potting the ends of the bundles creating a fluid-tight seal with the housing after the inserting step.

6. The method of claim 1, wherein the treating step further comprises treating with gamma irradiation.

7. The method of claim 6, wherein the step of treating with gamma irradiation further comprises treating with a dose of gamma irradiation ranging from 12.5 kGy to 175 kGy.

8. The method of claim 1, wherein the treating step further comprises treating with electromagnetic radiation emitted during plasma treatment.

9. The method of claim 8, wherein the plasma treatment is gas plasma treatment.

10. The method of claim 9, wherein the gas plasma treatment is radio frequency glow discharge.

11. The method of claim 1 wherein the treating step further comprises treating with both gamma irradiation and gas plasma.

12. The method of claim 1, wherein the membrane is comprised of a polyvinyl-pyrrolidone and a polymer selected from the group consisting of polysulfone, polyethersulfone or polyarylethersulfone.

13. The method of claim 1 wherein the membrane is a flat sheet membrane.
